(19) United States
(12) Patent Application Publication
(10) Pub. No.: US 2026/0296673 A1
(43) Pub. Date: Oct. 1, 2026

(54) Systems and Methods for Enhanced Aircraft Lighted Panels

(71) Applicant: IDD AEROSPACE CORPORATION, Redmond, WA (US)

(72) Inventor: Mark Liebendorfer, Redmond, WA (US)

(73) Assignee: IDD Aerospace Corporation, Redmond, WA (US)

(21) Appl. No.: 19/489,838

(22) PCT Filed: Jul. 21, 2023
(86) PCT No.: PCT/US2023/028349

§ 371 Date: Dec. 3, 2025

(51) Int. Cl. B64D 47/02; H01H 9/18; H05B 47/105; H05B 47/155; H05B 47/175; H05B 47/185

(52) U.S. Cl. CPC B64D 47/02; H05B 47/105; H05B 47/155; H05B 47/185

(57) ABSTRACT

Systems and methods for driving and controlling a plurality of lighted panels in a vehicle are described. Preferably, at least some of the existing lighted panels of an aircraft or other vehicle can be replaced with enhanced lighted panels that are individually addressable. Importantly, the enhanced lighted panels utilize the existing two-wire system of the vehicle, such that no new wiring is required. A control unit can be used to dim the existing and enhanced lighted panels, while also transmitting to, and receiving data, from the enhanced lighted panels. In this manner, the control unit can cause one of the lighted panels, or a region of that lighted panel, to change how the light sources illuminate, such as changing in color, brightness or other aspects.

### FIELD OF THE INVENTION

The field of the invention is lighted panels.

### BACKGROUND

The following description includes information that may be useful in understanding the present invention. It is not an admission that any of the information provided herein is prior art or relevant to the presently claimed invention, or that any publication specifically or implicitly referenced is prior art.

In today's aircraft, pilot instruments are typically backlit using incandescent lights, LED lights or electroluminescent displays. These lighted panels are designed to provide optimal visibility to the pilot, especially during low-light conditions, while minimizing distractions and eye strain.

The lighted panels are generally simple panels that include labels of cockpit controls and one or more light sources adjacent to the controls or labels. During the day, the labels or indicia are visible from reflected ambient light. At night, the lighted panels are backlit using internal lighting circuits. The lighted panels typically are part of the front panel of aircraft control panel assemblies.

The lighted panels typically have indicia, knobs, buttons, and so forth, which are backlit to the same level, and usually in some colour temperature of white. The lighted panels are typically grouped together and driven in parallel across the same two-wire power connection.

FIG. 1 shows an example of a conventional lighted panel 100 for an aircraft.

FIG. 2 illustrates an electrical diagram for conventional lighted panels 100 that are electrically connected in parallel to a dimming control unit (DCU) 110.

To control the brightness of the lighted panels, aircraft are typically equipped with a master dimming control 120, which is connected to the dimming control unit 110. The dimming control 120 allows a pilot to adjust the brightness of all of the lighted panels 100 and other lighting in the cockpit by turning a knob or pressing a button of the control 120. The dimming control unit 110 is typically connected to the lighted panels 100 in parallel using a two-pin connection. The connection utilizes two electrical conductors or wires that supply electrical power to the lighted panels 100, with one wire carrying the positive (+) electrical charge and the other wire carrying the negative (−) electrical charge.

Unfortunately, conventional lighted panels only allow for dimming of the brightness, such as to adjust for ambient light, but cannot provide notifications or other alerts to the pilots. While OLED or other displays could be used to replace the conventional lighted panels, such solutions would require new wiring, controls, and additional reviews by regulators. This increases the overall cost and time to retrofit the aircraft, which can be disadvantageous.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved lighted panels that utilize the existing two-wire connections of the conventional lighted panels.

### SUMMARY OF THE INVENTION

The inventive subject matter provides apparatus, systems and methods that utilize enhanced or smart lighted panels as replacements for existing lighted panels of the aircraft or other vehicle.

As used herein, the term “lighted panel” comprises lightplates, integrated switch panels (ISPs), and any component having an array of controls dedicated to a specific purpose and that utilize a set of LEDs or other light sources for backlighting or to visually indicate a status. The lighted panels are unable to display visual content such as text, images, or videos due to the limited number of light sources on the panel and/or the proximity of the light sources to one another. For example, contemplated lighted panels may have only a handful of light sources and will have less than 20-40 light sources per square meter.

In contrast, as used herein, a “lighted panel” does not include computer monitors, CRT displays, LCD displays, LED, OLED, or other flat panel displays that utilize an array of LED or other light sources to display visual content. Such displays could have 40,000 or more LEDs per square meter.

It is contemplated that an enhanced lighted panel is configured to alter an appearance of one or more light sources to contrast with other light sources of the lighted panel and/or other lighted panels and call attention to the lighted panel or a specific portion thereof. For example, the enhanced lighted panel may specially illuminate backlit features of the lighted panel in colors other than that of the background color (usually white) and/or may specially illuminate using patterns of flashing, pulsing, chasing, etc.

In this manner, the enhanced lighted panels can highlight controls or indicators that require immediate attention. This will allow aircraft and other vehicles to present alerts and warnings to increase pilot situational awareness. Although the discussion herein may focus on an aircraft, it is contemplated that the systems and methods discussed herein could similarly be used on ships, trains, busses, and other vehicles, as well as content delivery systems and methods for use outside of vehicles.

The enhanced lighted panels are also configured to have dimming functionality in addition to the special illumination capabilities described above.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a conventional lighted panel, where the lighted panel illuminates in white light.

FIG. 2 illustrates an electrical diagram showing an existing system for driving conventional lighted panels.

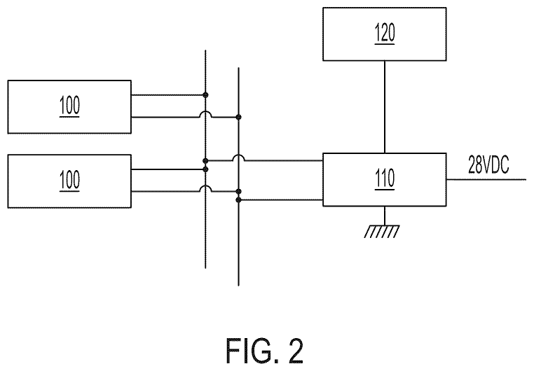

FIG. 3 illustrates one embodiment of an enhanced lighted panel.

FIG. 4 illustrates a diagram showing one embodiment of a system for driving and controlling a plurality of lighted panels in a vehicle.

FIG. 5 illustrates a diagram showing another embodiment of a system for driving and controlling a plurality of lighted panels in a vehicle.

### DETAILED DESCRIPTION

Throughout the following discussion, references may be made regarding servers, services, interfaces, portals, platforms, control units, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The terms, “component”, “module”, “system”, “unit”, and the like used herein indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Illustrative logical blocks, configurations, modules, circuits, means, logic, and algorithm operations described herein may be implemented by electronic hardware, computer software, or in a combination of electronic hardware and computer software. In order to clearly exemplify interchangeability of hardware and software, the algorithms, steps and/or operations have been generally described in the functional aspects thereof. Whether the functionality is implemented as hardware or software depends on the specific application or design restraints given to the system.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

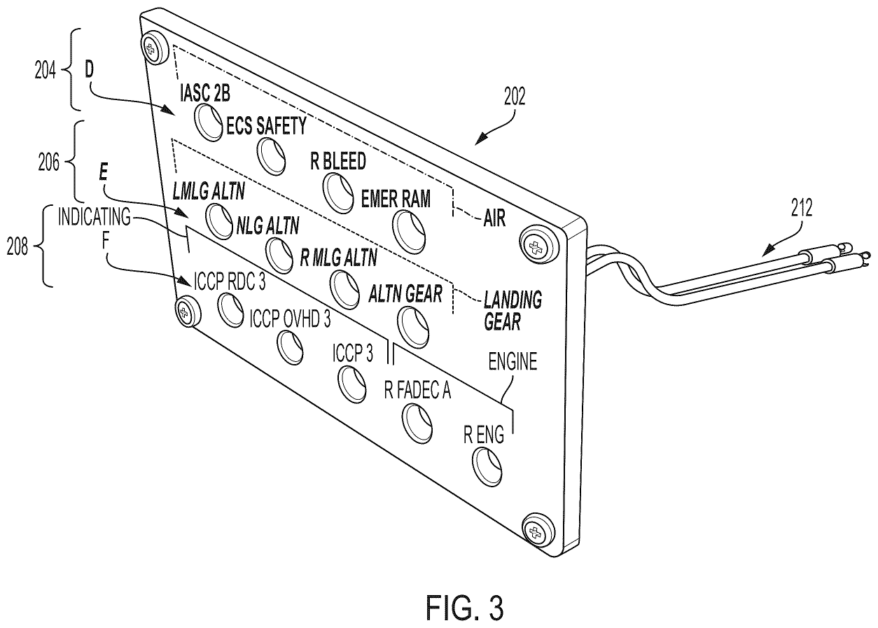

FIG. 3 illustrates one embodiment of an enhanced lighted panel 202. As shown, the lighted panel 202 comprises a first region 204, a second region 206, and a third region 208, each of which is isolated from the other regions and can be separately addressed and illuminated in one or more colors. The lighted panel 202 is electrically connected and controlled using a two-wire connection 212.

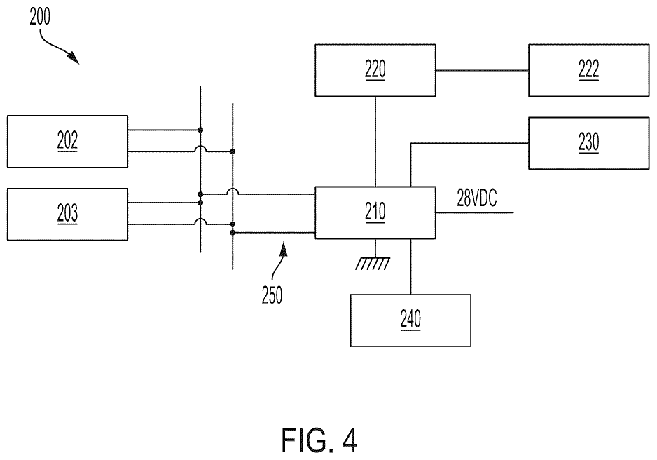

FIG. 4 illustrates one embodiment of a system 200 for driving and controlling a plurality of lighted panels in a vehicle. System 200 comprises a control unit 210, a first lighted panel 202 and a second lighted panel 203. As shown, each of the first lighted panel 202 and the second lighted panel 203 are connected in parallel with the control unit 210 by a two wire or two-pin connection 250. Thus, the first and second lighted panels 202, 203 are powered and controlled only by using a two-pin connection 250. It is contemplated that the system could have different sets of lighted panels, with each set having a separate bus with its own addressed clients (lighted panels) that are controlled independently from one another.

Preferably, each of the first and second lighted panels 202, 203 comprises an enhanced or smart lighted panel that is individually addressable and therefore can receive targeted signals from the control unit 210. Each of the first and second lighted panels 202, 203 preferably has two or more regions or zones that can be individually controlled and addressed (such as shown in FIG. 3), such that an illumination of light sources in one of the regions or zones can be changed to be different from an illumination of light sources in the other regions or zones of that lighted panel.

As one example, the lighted panel may change a color of light emitted from the light sources in a first region or zone to be different from a color of light emitted from the light sources in the other regions or zones of that lighted panel. As another example, the lighted panel may change a brightness of light emitted from the light sources in a first region or zone to be different from a brightness of light emitted from the light sources in the other regions or zones of that lighted panel. As another example, the lighted panel may cause the light sources of the first region to blink or flash.

It is especially preferred that each of the first and second lighted panels 202, 203 replaced a conventional lighted panel that was not individually addressable.

The control unit 210 is configured to drive each of the first and second lighted panels 202, 203 via the two wire connections. It is contemplated that the control unit 210 can control dimming of the first and second lighted panels 202, 203, such as by pulse width modulation (PWM) or other means. PWM dimming can be implemented using different types of control circuits, such as microcontrollers, specialized PWM controllers, or analog circuits, which can control the current or voltage supplied to the light source(s).

In some embodiments, the control unit receives a signal from a dimmer unit 220, and controls dimming of the first and second lighted panels 202, 203 based on the received signal from the dimmer unit 220. It is contemplated that the signal may be based on sensor data such as from one or more ambient light sensors 222 or could be based on actuation of an input such as a button or knob.

In some embodiments, the control unit 210 is further configured to receive information or commands from a data acquisition unit 230. The received information could comprise sensor or other received data such as from another system or component of the vehicle, flight control data, a control signal, one or more parameters from another (disparate) system of the vehicle, and so forth. It is contemplated that the control unit 210 may be fed a collated stream of aircraft event data and possibly some direct inputs from aircraft subsystems. The control unit 210 preferably is programmed to analyze the received data to determine important events pertinent to the functionality of lighted panels 202, 203. The control unit 210 may then digitally signal the pertinent lighted panels (through power wiring) to give appropriate indication to a pilot, for example. The control unit 210 continues to supply nighttime dimming control which would supply dimming commands to the lighted panels 202, 203 so they illuminate at the same user-selected level.

The control unit 210 is configured to also transmit data to at least one of the first and second lighted panels 202, 203 over the two-wire connection. In some embodiments, the control unit 210 transmits data to the at least one of the first and second lighted panels 202, 203 based on the received information from the data acquisition unit 230. Thus, the alert notification can be transmitted to the lighted panel without having to add new wiring to the existing two wire power wiring.

The transmission of data over power lines may utilize data over power, also known as power over ethernet (PoE). Typically, this involves altering the amplitude, frequency, or phase of (i.e., modulating) the electrical signal to encode the data, and the modulated data signals are then simultaneously transmitted over the same two wire connection with the power signals.

It is contemplated that each of the lighted panels 202, 203 can have a receiver that can decode and extract the data signals from the power signals.

Because each of the first and second lighted panels 202, 203 are individually addressable, the data can be specifically targeted or addressed to a specific one of the second lighted panels 202, 203 and even a specific region or zone of light sources of that lighted panel.

Based on the received data, it is contemplated that the first lighted panel 202 changes an illumination of some or all of the light sources on the first lighted panel 202. As discussed above, the first lighted panel 202 may have two or more regions or zone, which can be individually controlled such that the first lighted panel 202 can change an illumination of the light sources of one of the regions based on the received data from the control unit 210. In this manner, an illumination of the light sources of a specific region of the first lighted panel 202 can be changed to be different from an illumination of the light sources in the other regions or zones of that lighted panel. Exemplary changes could be a change of the color of light illuminated by the light sources of the specific region, an increase in brightness of the light illuminated by the light sources of the specific region, or a flashing or blinking of the light sources of the specific region.

Thus, unlike the standard or conventional lighted panels, which can be replaced by the enhanced lighted panels described herein, the enhanced lighted panels could highlight controls requiring the operator's immediate attention. For example, if there is an engine fire, information concerning the fire could be sent from the data acquisition unit 230 to the control unit 210, which transmits data to the first lighted panel 202. In response, the first lighted panel 202 can select features on a fire control region of the panel 202 (which may normally be illuminated in white light) and change the light sources of that region to illuminate a red light or to flash red to alert the pilot and crew.

It is further contemplated that the control unit 210 may receive a signal directly from an ambient light sensor 240 such as to detect an amount of ambient light in the cockpit, for example. Based on this signal, the control unit 210 may transmit data to one or both of the first and second lighted panels 202, 203 to cause a change in brightness of the light sources on the lighted panel(s). For example, during daytime hours, the signal from the ambient light sensor 240 may cause the first and second lighted panels 202, 203 to increase a brightness of light emitted by the light sources of the panels to ensure alerts are able to be seen by a pilot.

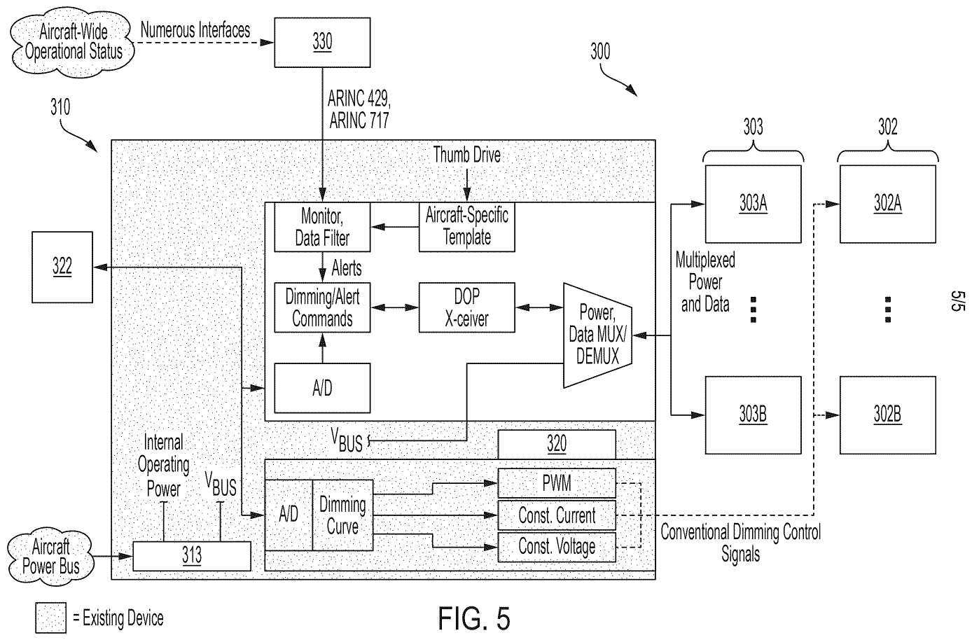

FIG. 5 illustrates another embodiment of a system 300 for driving and controlling a plurality of lighted panels in a vehicle. System 300 comprises a control unit 310 which could be a data over power controller, for example, a first set of lighted panels 302 and a second set of lighted panels 303. Each lighted panel of the first set of lighted panels 302 is connected in parallel with the control unit 310 by a first two wire connection.

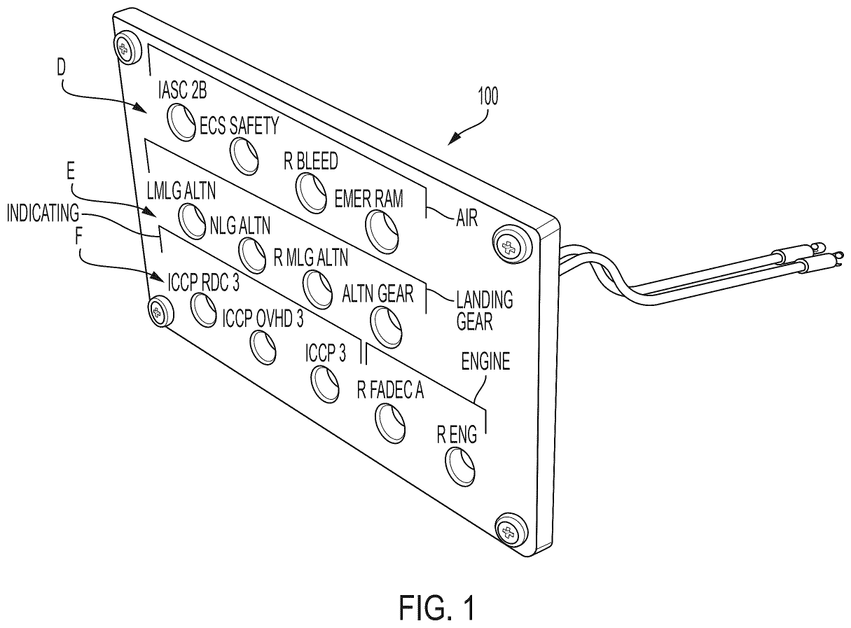

The first set of lighted panels 302 comprises at least a first lighted panel 302A and a second lighted panel 302B, which are each electrically connected in parallel to the control unit 310 by a two wire connection. It is contemplated that the lighted panels of the first set 302 may comprise conventional or standard lighted panels such as described in FIG. 1, and that are not individually addressable. However, in other embodiments, it is contemplated that some or all of the lighted panels of the first set 302 are enhanced lighted panels that are individually addressable.

Preferably, each lighted panel of the second set of lighted panels 303 comprise enhanced lighted panels that are individually addressable and connected in parallel with the control unit 310 by a second two wire connection. To best appeal to the retrofit market, the replacement or enhanced lighted panels of the second set 303 utilize existing two-wire power connections already installed in the aircraft or other vehicle and are sized and dimensioned to fit in the same physical space as a conventional lighted panel.

The second set of lighted panels 303 comprises at least a third lighted panel 303A and a fourth lighted panel 303B, which are each individually addressable and are electrically connected in parallel to the control unit 310 by a two pin connection. It is contemplated that the lighted panels of the first set 303 comprise smart or enhanced lighted panels such as that described in FIG. 3, such that the lighted panels can receive targeted signals from the control unit 310.

These individually addressable panels may have two or more zones or regions of light sources, which can be individually controlled to thereby draw attention to a specific zone or region of the lighted panel by changing an illumination of light sources in one of the regions or zones to be different from an illumination of light sources in the other regions or zones of that lighted panel.

As one example, each of the lighted panels of the second set 303 may change a color of light emitted from the light sources in a first region or zone to be different from a color of light emitted from the light sources in the other regions or zones of that lighted panel. As another example, each of the lighted panels of the second set 303 may change a brightness of light emitted from the light sources in a first region or zone to be different from a brightness of light emitted from the light sources in the other regions or zones of that lighted panel. As another example, each of the lighted panels of the second set 303 may cause the light sources of a first region to blink or flash.

It is especially preferred that each lighted panel of the second set 303 receives power only by the two wire (two pin) connection. It is also preferred that each of the lighted panels of the second set 303 replaced a conventional lighted panel that was not individually addressable and without the need for additional or new wiring.

The control unit 310 can be configured to receive power to an internal power supply 313 and is configured to drive each of the lighted panels of the first and second sets 302, 303 via the two wire connections. It is contemplated that the control unit 310 can control dimming of each of the lighted panels of the first and second sets 302, 303, such as by pulse width modulation (PWM) or other means. As discussed above, PWM dimming can be implemented using different types of control circuits, such as microcontrollers, specialized PWM controllers, or analog circuits.

In some embodiments, the lighted panels of the first and second sets 302, 303 can be driven together using the same power waveform and the existing two wire connectors. In such embodiments, the power waveform is bipolar and contains a combination of conventional and enhanced lighted panel signals. An input diode can be added to the standard lighted panels of the first set 302. Standard LED lighted panels may require new resistor values.

As one example, the special bipolar waveform may be multiplexed by having all of the waveform below zero supply power and data to the enhanced lighted panels of the second set 303. Those lighted panels of the second set 303 may contain an input rectifier to block voltage of positive polarity. The other half of the waveform would be above zero and would be pulse width modulated to supply conventional dimming to LED or incandescent lighted panels. All standard lighted panels of the first set 302 would have a blocking diode added to their power inputs.

The lighted panels of the first set 302 are typically wired in groups, with each group being dimmed using PWM or other scheme. In contrast to the lighted panels of the first set 302, the lighted panels of the second set 303 require constant direct current (DC) or alternating current (AC) power. Because of this, it is contemplated that the lighted panels of the first set 302 are in a different wiring group than the lighted panels of the second set 303. However, all of the lighted panels are powered by and connected to the control unit 310 by a two wire connection.

In some embodiments, the control unit 310 comprises or is communicatively coupled with a dimming unit 320, which can be configured to control dimming of the lighted panels of the first set 302 or second set 303 based on a received signal from one or more ambient light sensors or could be based on actuation of an input such as a master dimmer control 322 having a button or knob. In such embodiments, it is contemplated that the dimming unit 320 comprises circuitry to provide dimming of the lighted panels of the first set 302 or second set 303. In some embodiments, the dimming unit can drive the first set 302 of lighted panels using a constant current/voltage and PWM.

Thus, the control unit 310 can drive backlighting of existing conventional lighted panels (e.g., lighted panels 302A, 302B) using established methods and separately drive the second set 303 of enhanced lighted panels with a multiplexed combination of constant operating voltage and bidirectional digital data. The bidirectional data flow with the lighted panels of the second set 303 allow for the lighted panels to receive and send data. For example, the lighted panels could send sensor data (e.g., light, temperature, etc.) or touch panel data (e.g., mouse input, slider, knob, etc.) to the control unit 310.

The control unit 310 can therefore continue to supply nighttime dimming control for all of the lighted panels 302, 303, by supplying dimming commands to the second set 303 of enhanced lighted panels and standard dimming voltage to the first set 302 of conventional lighted panels so each of the lighted panels will illuminate at the same user-selected level.

The control unit 310 can output dimming control voltage or current waveforms to groups of lighted panels each of a single technology and specification (e.g., incandescent lamps, LEDs, electroluminescent, etc.). Each group can be driven in its own required way thus permitting all lighted panels in the cockpit to dim together.

In some embodiments, the control unit 310 is further configured to receive information or commands from a data acquisition unit 330. The received information could comprise sensor or other received data such as from another system or component of the vehicle, flight control data, flight status, a status of the vehicle, one or more parameters from another (disparate) system of the vehicle, a control signal, and so forth. As discussed above, it is contemplated that the control unit 310 may be fed a collated stream of aircraft event data and possibly some direct inputs from aircraft subsystems. The control unit 310 preferably is programmed to analyze the received data to determine important events that are related or pertinent to the functionality of the second set of lighted panels 303. The control unit 310 may then digitally signal (i.e., transmit data to) the pertinent lighted panels (e.g., panel 303A or panel 303B) (through power wiring) to give appropriate indication to a pilot, for example. The control unit 310 continues to supply nighttime dimming control which would supply dimming commands to the lighted panels 302, 303 so they illuminate at the same user-selected level at others of the lighted panels.

The control unit 310 can therefore transmit data to the third lighted panel 303A and the fourth lighted panel 303B over the two-wire connection such as by using a data over power or another powerline carrier transceiver. Thus, data can be transmitted to the lighted panels to cause them to change an illumination without having to add new wiring to the existing two wire power wiring of the aircraft or other vehicle. As discussed above, the transmission of data over power lines may utilize data over power, also known as power over ethernet (PoE). It is contemplated that each of the lighted panels 303A, 303B can have a receiver that can decode and extract the data signals from the power signals. Because each of the lighted panels 303A, 303B are individually addressable, the data can be specifically targeted or addressed to a specific one of the lighted panels 303A, 303B and even a specific region or zone of light sources of that lighted panel.

To individually address the lighted panels in a series electrical connection, any commercially suitable technique could be used. The target lighted panel or zone/region of the lighted panel can be identified by the control unit 310, and data can be transmitted over the power line two wire connection to the lighted panel.

Information from the data acquisition unit 330 can be received by the control unit 310 over any commercially suitable standards including, for example, ARINC 717 and ARINC 429. ARINC 717 and ARINC 429 are digital data bus standards that are commonly used in aircraft avionics systems to transfer data between different avionics components.

Based on the received data from the control unit 310, one of the lighted panels 303A, 303B (or a region/zone thereof) changes an illumination of some or all of the light sources on the targeted lighted panel of the second set 303. As discussed above, each of the lighted panels 303A, 303B may have two or more regions or zones, which can have its own set of light sources that is individually controlled such that the lighted panels 303A, 303B can change an illumination of the light sources of one of the regions/zones based on the received data from the control unit 310. As an example, the third lighted panel 303A may comprise a first region having a first set of light sources and a second region having a second set of light sources.

In this manner, an illumination of the light sources of a specific region of the third lighted panel 303A, for example, can be changed to be different from an illumination of the light sources in the other regions or zones of that lighted panel. Exemplary changes could be a change of the color of light illuminated by the light sources of the specific region, an increase in brightness of the light illuminated by the light sources of the specific region, or a flashing or blinking of the light sources of the specific region.

Thus, unlike the standard or conventional lighted panels (e.g., panels 302A, 302B) of the first set 302, the enhanced lighted panels of the second set 303 can highlight controls requiring the pilot's immediate attention. For example, if there is an engine fire, information concerning the fire could be sent from the data acquisition unit 330 to the control unit 310, which transmits data to a fire control region of one of the lighted panels 303A, 303B. In response, that lighted panel can change an illumination of the light sources of that region to a different color or to flash or blink alert the pilot and/or crew.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A system for driving and controlling a plurality of lighted panels in a vehicle, comprising:
a control unit;
a first set of lighted panels comprising at least one lighted panel, each lighted panel of the first set is connected in parallel with the control unit by a first two wire connection;
a second set of lighted panels comprising at least one lighted panel, each lighted panel of the of the second set is individually addressable and is connected in parallel with the control unit by a second two wire connection;
wherein the control unit is configured to drive each of the lighted panels of the first and second sets via the first and second two wire connections, respectively; and
wherein the control unit is further configured to (i) control dimming of the first set or second set of lighted panels and (ii) transmit data to at least one lighted panel of the second set of lighted panels over the second two wire connection.

2. The system of claim 1, wherein the control unit is further configured to receive information from a data acquisition unit, and wherein the control unit transmits data to the at least one lighted panel of the second set based on the received information.

3. The system of claim 2, wherein the received information comprises sensor data or flight control data.

4. (canceled)

5. The system of claim 2, wherein the received information comprises one or more parameters from a disparate system of the vehicle.

6. The system of claim 1, wherein the at least one lighted panel of the second set comprises a first region having a set of light sources and a second region having a second set of light sources, wherein the first and second regions are individually addressable, and wherein the at least one lighted panel changes an illumination of the light sources of the first region based on the received data from the control unit.

7. The system of claim 6, wherein the at least one lighted panel changes a color of light emitted from the light sources of the first region based on the received data from the control unit.

8. The system of claim 6, wherein the at least one lighted panel increases a brightness of light emitted from the light sources of the first region based on the received data from the control unit.

9. The system of claim 6, wherein the at least one lighted panel causes the light sources of the first region to blink or flash based on the received data from the control unit.

10. The system of claim 1, wherein each of the lighted panels of the second set are electrically coupled to the control unit only by the second two wire connection.

11. The system of claim 1, wherein each lighted panel of the first set is individually addressable, and wherein the control unit is further configured to transmit data to at least one lighted panel of the first set of lighted panels over the first two wire connection.

12. A system for driving and controlling a plurality of lighted panels in a vehicle, comprising:
a control unit configured to receive information from a data acquisition unit of the vehicle, wherein the information comprises at least one of a status of the vehicle, a flight status, received data, or a control signal;
first and second lighted panels that are electrically connected in parallel to the control unit by a two pin connection;
third and fourth lighted panels that are each individually addressable, wherein the third and fourth lighted panels are electrically connected in parallel to the control unit by a two pin connection;
wherein the control unit powers each of the first, second, third, and fourth lighted panels via the two pin connection, such that the control unit controls a brightness of each of the first, second, third, and fourth lighted panels; and
wherein the control unit is configured to transmit a command signal to the third lighted panel using the two pin connection and based on the received information from the data acquisition unit.

13. The system of claim 12, wherein the control unit is configured to receive a signal from a dimmer unit, and wherein the control unit controls the brightness of each of the first, second, third, and fourth lighted panels based on a signal received from the dimmer unit.

14. The system of claim 12, wherein the received information comprises sensor data or flight control data.

15. (canceled)

16. The system of claim 12, wherein the received information comprises one or more parameters from a disparate system of the vehicle.

17. The system of claim 12, wherein the third lighted panel comprises a first region having a first set of light sources and a second region having a second set of light sources, wherein the first and second regions are individually addressable, and wherein the third lighted panel changes an illumination of the light sources of the first region based on the received command signal.

18. The system of claim 17, wherein the third lighted panel changes a color of light emitted from the light sources of the first region based on the received command signal, such that the color of light emitted from the light sources of the first region is different from a color of light emitted from the light sources of the second region.

19. The system of claim 17, wherein the third lighted panel increases a brightness of light emitted from the light sources of the first region based on the received command signal, such that the brightness of light emitted from the light sources of the first region is greater than a brightness of light emitted from the light sources of the second region.

20. The system of claim 17, wherein the third lighted panel causes the light sources of the first region to blink or flash based on the received command signal.

21. The system of claim 12, wherein the third and fourth lighted panels are electrically coupled to the control unit only by the two pin connection, such that both power and data are received over the two pin connection.

22. The system of claim 12, wherein the control unit is configured to transmit a command signal to the first lighted panel using the two pin connection and based on the received information from the data acquisition unit.
